(19) United States
(12) Patent Application Publication
(10) Pub. No.: US 2012/0000378 A1
(43) Pub. Date: Jan. 5, 2012

(54) COMBINATION STAMPING AND EMBOSSING IMPLEMENT AND SEAL HAVING ENHANCED SECURITY FEATURES

(76) Inventors: Shawn Slane, Waseca, MN (US); Daniel A. Eke, Minneapolis, MN (US)

(21) Appl. No.: 12/829,991

(22) Filed: Jul. 2, 2010

(51) Int. Cl. B44B 5/02; B44C 1/24

(52) U.S. Cl. 101/18; 101/32

(57) ABSTRACT

A combination embosser and printing system. The combination embosser and printing system creates a raised seal or image having one or more areas of inked image in and/or around the raised image. The combination embossing and printing system is adapted to emboss and print a substrate in a single actuation of the system. The system generally includes an embossing assembly adapted to form at least one raised image area on a substrate and a printing assembly adapted to form at least one inked image area on the substrate.

### FIELD OF THE INVENTION

The present invention is directed generally to stamping and embossing technologies. More specifically, the present invention is directed to a die set for a combination embosser and printing system.

### BACKGROUND OF THE INVENTION

Embossed seals, such as a notary seal, are often used as a form of certific ation or authentication of a document or signature on a document, such as, for example, checks, cashier's checks, oaths, declarations, and affidavits. Such seals can be in the form of adhesive seals or more commonly, a raised image formed directly onto the document substrate such as paper.

In the specific case of an embossed seal, such as a notary seal, the seal is formed from a hand-held or clamp-like embossing instrument called an embosser. The embosser typically includes a die set comprising a die (female) and counter die (male), operable with a handle assembly. A substrate is placed between the dies. The dies are then brought together to squeeze the substrate with the application of pressure to the handle assembly to create a raised image on the substrate. Embossing technology, although difficult to reproduce the image, provides limited detail to the seal, no color capabilities, and can be difficult to use.

Another form of certifying or authenticating a document is the application of a custom ink stamp to the substrate. Stamping technology is herein defined as the use of a rubber media having a desired image and/or text thereon and ink to transfer the image to the substrate. Stamps can be available in an ink pad and stamp set, or more commonly can be in the form of a self-inking stamper in which the stamper includes an ink pad or ink supply within the housing of the stamper, and a stamp face is automatically inked in use without the need for a separate ink pad. Unlike embossing technology, stamps offer fine detail, color capabilities, and are relatively easy to use. The image of a stamp is easier to copy than an embosser image.

The current stamp and embossing technologies however are prone to fraudulent activity. For example, it is possible to copy a notary seal and subsequently use that seal to commit fraud. A stamp seal or image is copied easily if obtained from the true seal owner. Even if the true seal owner keeps the embosser in a tightly controlled or locked environment, a likeness of the stamp or seal can be sold on the black market, for example, by the notary stamp company. The true seal owner is unaware that their seal likeness has been stolen because they are still in possession of the stamp or embosser.

When a document or other instrument that contains a seal is received, it is often presumed that the document is authentic. In many fraud cases, the fraud is not realized early enough to prevent economic damage.

One specific example of the use of fraudulent seals is in the real estate market. Fake notary seals are used in real estate scams, typically involving land with an out-of-state owner. The criminal uses the seal on a deed from the purported property owner to an accomplice. The property is then later sold without the real property owner's knowledge. The proceeds are routed to a bank account. Once the proceeds are deposited into the account, the criminals are virtually impossible to locate. Sometimes, the legal property owner might not find out that the property has been stolen for years.

There remains a need for a seal-forming instrument that provides enhanced security from either stamping or embossing technologies, yet is relatively easy to use.

### SUMMARY OF THE INVENTION

A combination embosser and printing system according to embodiments of the present invention solve many of the above-described deficiencies of stamping and embossing technologies used independently of each other. The combination embosser and printing system creates a raised seal or image having one or more areas of inked image in and/or around the raised image.

In one embodiment of the invention, the combination embossing and printing system is adapted to emboss and print a substrate in a single actuation of the system. The system generally comprises an embossing assembly adapted to form at least one raised image area on a substrate and a printing assembly adapted to form at least one inked image area on the substrate.

The embossing assembly can include a first die presenting a contact face having at least one recessed image area defined thereon, and a second, counter die presenting a contact face having at least one respective complementary raised image area defined thereon. The printing assembly including a stamp face having at least one stamping image area defined thereon, the stamp face being positioned on the contact face of the first die or the second die of the embossing assembly.

In use, a substrate, such as paper, foil, plastic, and the like, is placed between the first and second dies of the embossing assembly. The at least one raised image area and the at least one inked image area are formed on the substrate when the contact faces of the first and second dies of the embossing assembly are brought together, sandwiching the substrate therebetween. The embossing and printing can be performed simultaneously or can be staggered; however both the printing and embossing is performed within a single machine process cycle, i.e. the dies need only be brought together, or actuated, once to both emboss and print the substrate.

The combination embosser and printing system provides enhanced security from embossing or stamping technologies alone. The combination embosser and printing system provides fine detail and the option of color, while making it more difficult to fraudulently copy the seal or image.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1a is a perspective view of a die set according to an embodiment of the invention;

FIG. 1b is a perspective view of the embossing die of the die set of FIG. 1a;

FIG. 1c is a perspective view of the counter die of the die set of FIG. 1a;

FIG. 2a is a perspective view of an embossing die according to an embodiment of the present invention;

FIG. 2b is a side view of the embossing die of FIG. 2a;

FIG. 2c is a top view of the embossing die of FIG. 2a;

FIG. 3a is a perspective view of an embossing die according to an alternative embodiment of the present invention;

FIG. 3b is a side view of the embossing die of FIG. 3a;

FIG. 3c is a top view of the embossing die of FIG. 3a;

FIG. 4a is a perspective view of an embossing die according to an alternative embodiment of the present invention;

FIG. 4b is a side view of the embossing die of FIG. 4a;

FIG. 4c is a top view of the embossing die of FIG. 4a;

FIG. 5 is a secure seal according to an embodiment of the present invention; and

FIG. 6 is a perspective view of an embosser and stamping implement according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

A combination embossing die and a stamp imaging system generally comprises an embossing die set including an embossing die and a counter die in combination with a printing system to create a raised or embossed image area having one or more inked imaged areas on a substrate. The embossing die set with printing system can be affixed to or otherwise used in combination with an implement, such as a desktop embosser, a handheld embosser, or an automatic embosser. The raised or embossed images in combination with the printed images are formed on the substrate in a single machine process cycle, i.e. one actuation of the die set. In the one machine process cycle, the raised and printed images can be formed either simultaneously or with a short time lag between the embossing and printing steps.

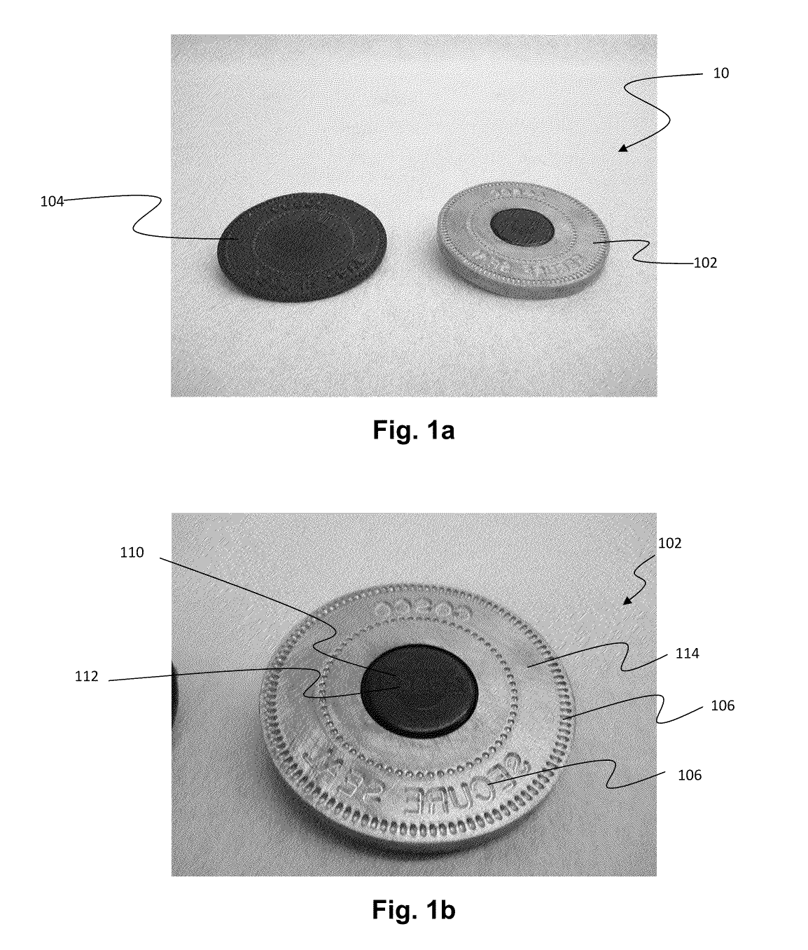

Referring to FIGS. 1a-1c, a combination embossing die and stamp imaging system 10 according to an embodiment of the invention generally can comprise a die set 100 including a female or embosser die 102 and a male or counter die 104. Embosser die 102 generally comprises one or more negative or recessed image areas 106 formed thereon as illustrated in FIG. 1b, while counter die 104 comprises one or more positive or raised image areas 108 formed thereon corresponding to the one or more recessed image areas 106 of embosser die 102 as illustrated in FIG. 1c. In an alternative embodiment of the invention not shown, an embosser die includes one or more raised image areas while the counter die comprises one or more recessed image areas corresponding to the raised image area(s) of the embosser die.

Corresponding image areas 106 and 108 can comprise any of a variety of static graphics, text, logos, protrusions, continually line features, and combinations thereof. For example, recessed image area 106 can comprise a plurality of wells forming a ring or circle, while raised image area 108 can comprise a plurality of protrusions forming the relief of the ring or circle.

Embosser die set 100 further includes a printing system for creating the printed image area on the substrate. The printing system can comprise one or more stamp faces 110 on embosser die 102, counter die 104, or both. As illustrated in FIG. 1c, stamp face(s) 110 includes one or more stamping image areas 112 defined thereon and an ink supply for inking the one or more image areas 112 as discussed in further detail infra.

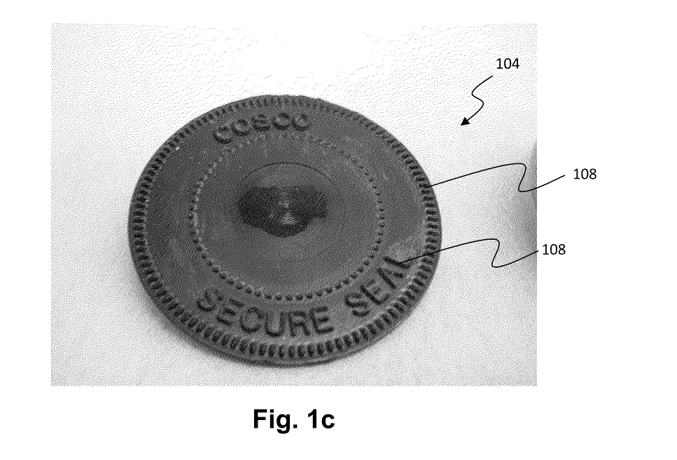

Referring to the embodiments of embosser die 102 illustrated in FIGS. 2a-4c, embosser die 102 generally comprises a contact face 114 having one or more embossing image areas 106, such as a negative image area (recesses), and one or more stamp faces 110 having one or more stamping image areas 112. Contact face 114 can comprise a suitable material, such as a metal including copper or brass, plastic including polyexymethylene (Delrin®), and combinations thereof. Contact face 114 is machined or otherwise formed with the desired seal or other graphics, text, and/or images to create image area(s) 106. Further, embosser die 102 can be machined with a recess or other aperture for receiving and retaining one or more stamp faces 110 having one or more image areas 112.

Stamp face 110 can comprise a suitable stamping material such as rubber, foam, plastic, and combinations thereof. Stamp face 110 can be imaged with image areas 112 before and/or after it is received within embosser die 102.

Stamp face 110 can comprise a pre-inked stamping material in which the ink is embodied in image area(s) 112, or can be used with a traditional ink pad in which stamp face 110 is brought into contact with an ink pad. The traditional ink pad can be a separate pad in which an implement having die set mounted thereon is applied to the pad, or the implement can have a self-inking configuration in which the ink pad is a part of the implement, and image area(s) 112 are brought into contact with the ink pad upon actuation of the implement.

In one embodiment of the invention, stamp face 110 comprises a flash-imageable open-cell rubber material. Image area(s) 112 are impregnated with ink or other printing media. The ink or other printing media is then trapped within image area(s) 112 of stamp face 110 for a pressure-controlled release when stamp face 110 is in contact with a substrate. Each image area can comprise the same color of ink, or different colors for each area.

In another embodiment of the invention, stamp face 110 comprises a heat-set gel ink. A liquid ink is poured into a mold of the desired stamp face. The ink is then cured to a solid forming stamp face 110 and set in embosser die 102 or counter die 104. A pressure-controlled amount of ink is then transferred to a substrate when the stamp face 110 is in contact with a substrate.

In yet another embodiment of the invention, stamp face 110 comprises a laser imageable open-cell rubber. The rubber is imaged using laser engraving or writing. Similar to the flash imageable rubber embodiment, image area(s) 112 are impregnated with ink or other printing media. Image area(s) 112 can be a single color or different colors. The ink or other printing media is then trapped within image area(s) 112 of stamp face 110 for a pressure-controlled release when stamp face 110 is in contact with a substrate.

For pre-inked stamp configurations, the ink supply of stamp face 110 diminishes after multiples uses such that the die set no longer produces a stamped image in combination with the embossed image. To replenish the ink supply, the die set is replaced, only the image areas of the stamp face are replaced, or the stamp face includes re-inking access ports or holes.

In one embodiment of the invention, further security is achieved by the use of a security features such as, for example, UV fluorescent ink, thermochromatic ink, hologram printing, micro-engraving, magnetic ink, DNA tracking, and combinations thereof.

In use, a substrate, such as a paper document, fabric, plastic, foil, and combinations thereof is imaged using die set 100 described above. Die set 100 is mounted or otherwise affixed in a desired implement. The substrate is placed in die set 100 between embosser die 102 and counter die 104 when die set 100 is in an open position, i.e. when embosser die 102 and counter die 104 are spaced apart.

Die set 100 is actuated by manual and/or automatic means for the corresponding implement. In one embodiment of the invention in which the die set is used in combination with a handheld or desktop embosser implement, pressure is applied to a handle assembly or other actuation assembly of the implement such that contact face 112 of embosser die 102 travels towards counter die 104 sandwiching the substrate in between. Ink is transferred from image area(s) 112 to a first side, second side, or both of the substrate depending on whether stamp face(s) 110 with image area(s) 112 are located on embosser die 102 and/or counter die 104 respectively. While the substrate is sandwiched between the dies, the substrate is also embossed with embosser image portion(s) 116 to create a raised image on a first side of the substrate simultaneously with, before, or after the printing step. The pressure is then released such that embosser die 102 travels away from counter die 104 back to the initial position, therefore completing one machine process cycle. The newly embossed and printed imaged substrate is then removed from the die set.

In an alternative embodiment of the invention, the one machine process cycle performed automatically, e.g. by a motor as opposed to manual pressure. The automatic actuation can be started by pressing a button or switch, for example, or by a sensor adapted to recognize when a substrate is placed between the dies of the die set.

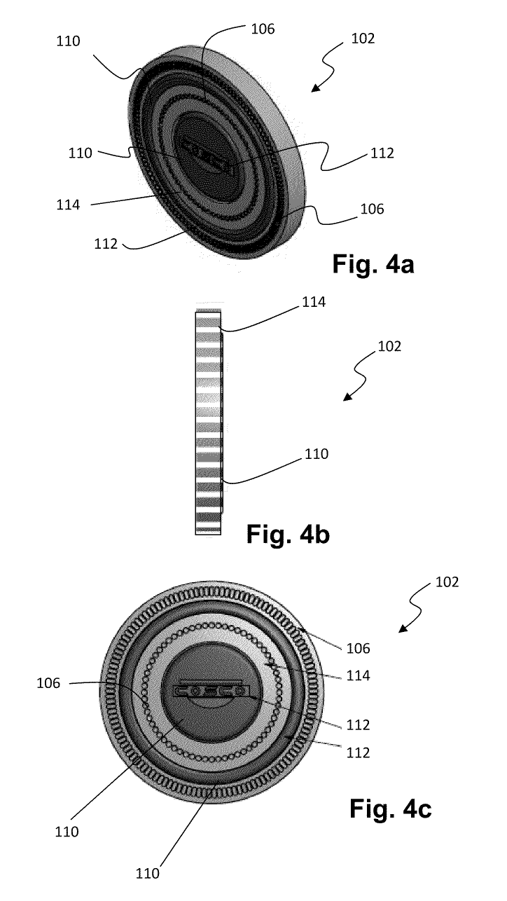

The resulting image can comprise any of a variety of seals, images, text, and combinations thereof. For example, the embosser die illustrated in FIGS. 2a-2c comprises a stamp image area 112 comprising a logo with text, positioned within two embossing image areas 106 forming two concentric circles, each circle comprising a plurality of recesses or wells. An exemplary seal formed form this particular embossing die of a die set is illustrated in FIG. 5.

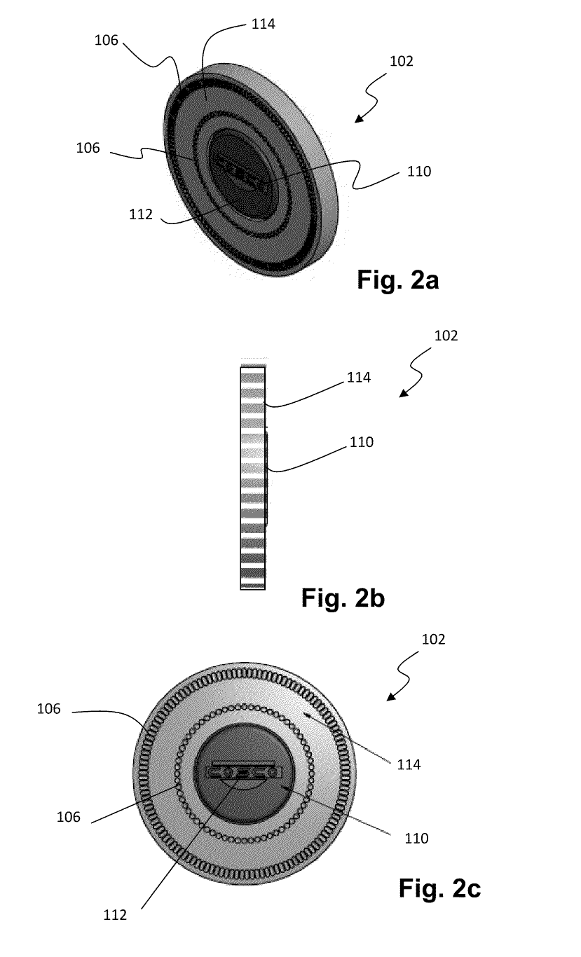

The embosser die illustrated in FIGS. 3a-3c comprises a stamp image area 112 in the form of a continuous ring positioned between two embossing image areas 106 forming two rings or circles, each ring comprising a plurality of recesses or wells. The resulting seal comprises three concentric circles alternating between embossed, printed, and embossed.

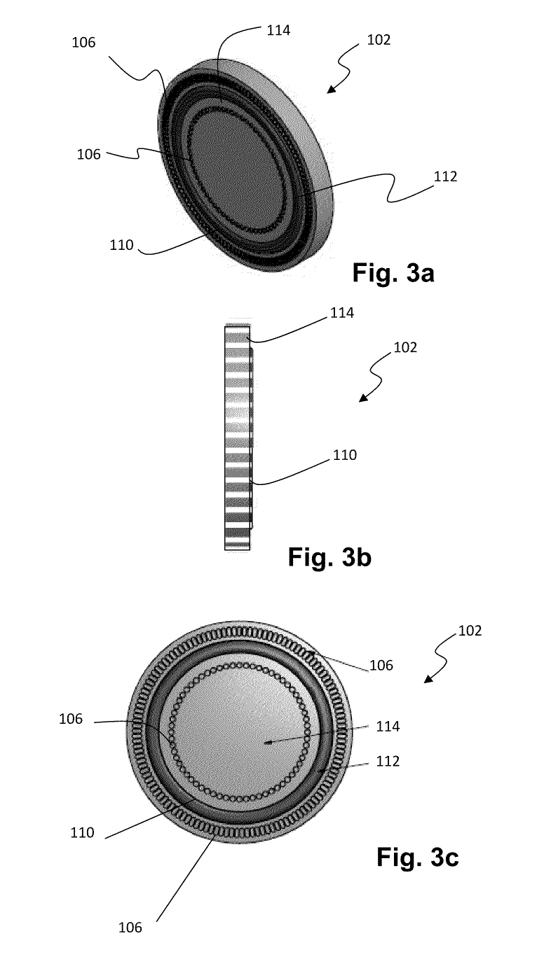

The embosser die illustrated in FIGS. 4a-4c comprises a combination of the stamp image areas and the embossing image areas of FIGS. 2a-3c to form a seal having three concentric circles alternating between embossed, printed, and embossed, with a printed logo in the center.

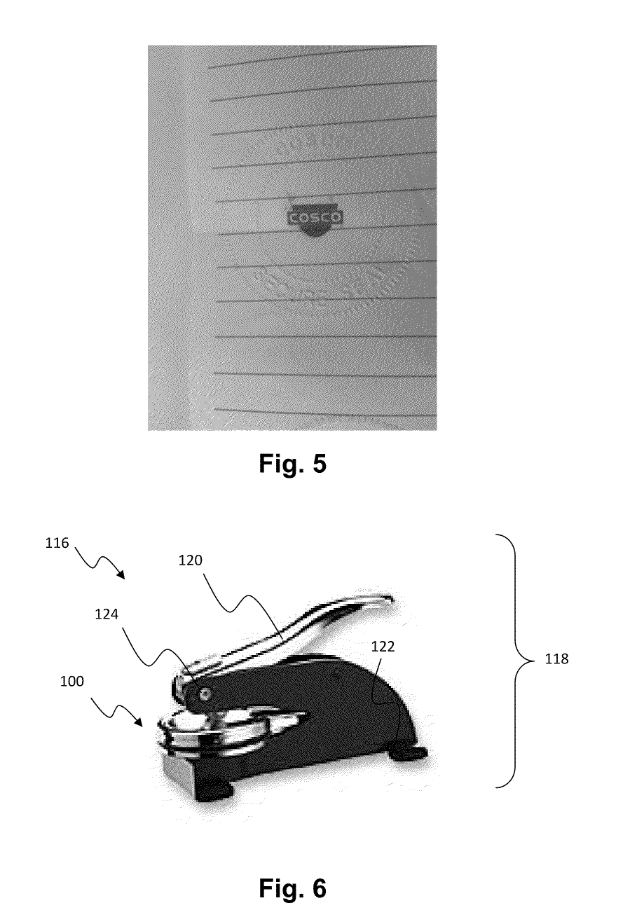

As described above, die set 100 can be used in any of a variety of implements such as a desktop embosser, handheld embosser, or automatic embosser. In one particular embodiment of the invention, illustrated in FIG. 6, die set 100 is used in combination with a handheld embosser implement 116. Implement 116 generally includes a handle assembly 118. Handle assembly 118 can comprise a handle 120 and a base 122, handle 120 being shiftable relative to base 122 about a fulcrum, such as a pivot pin 124 or other suitable pivoting device. Handle assembly 118 can be spring loaded. The spring (not shown) is preferably a compression spring.

In one embodiment, die set 100 can be removably attachable to implement 116 by any suitable means or mechanical fasteners. For example, embosser die 102 can be removably affixed to handle 120 while counter die 104 can be removably affixed to base 122 for ease and efficiency of replacement of one or both dies of die set 100. In another embodiment, each die of die set 100 is permanently affixed to the corresponding handle of implement 116.

The invention may be embodied in other specific forms without departing from the essential attributes thereof; therefore, the illustrated embodiments should be considered in all respects as illustrative and not restrictive. Any dimensions contained in the drawings are fore exemplary purposes only, and are not intended to be limiting.

What is claimed is:

1. A combination embossing and printing system adapted to emboss and print a substrate in a single actuation of the system, the system comprising:
an embossing assembly adapted to form at least one raised image area on a substrate, the embossing assembly including—
a first die presenting a contact face having at least one recessed image area defined thereon, and
a second, counter die presenting a contact face having at least one respective complementary raised image area defined thereon; and
a printing assembly adapted to form at least one inked image area on the substrate, the printing assembly including a stamp face having at least one stamping image area defined thereon, the stamp face being positioned on the contact face of the first die or the second die of the embossing assembly,
wherein the at least one raised image area and the at least one inked image area are formed on the substrate when the contact faces of the first and second dies of the embossing assembly are brought together, sandwiching the substrate therebetween.

2. The system of claim 1, wherein the stamp face is positioned on the contact face of the first die such that the at least one raised image and the at least one inked image is formed on a first major surface of the substrate.

3. The system of claim 1, wherein the stamp face is positioned on the contact face of the second die such that the at least one raised image is formed on a first major surface of the substrate and the at least one inked image is formed on a second, generally opposing major surface of the substrate.

4. The system of claim 1, wherein the printing assembly further comprises a second stamp face positioned on the other contact face of the first or second die from the first stamp face, such that the at least one raised image and a first inked image is formed on a first major surface of the substrate, and a second inked image is formed on a second, generally opposing major surface of the substrate.

5. The system of claim 1, wherein the stamp face comprises an open cell rubber material.

6. The system of claim 5, wherein the open cell rubber material is flash imageable or laser imageable to form the at least one stamping image area.

7. The system of claim 5, wherein each of the at least one stamping image areas is impregnated with ink.

8. The system of claim 7, wherein the ink comprises at least one of a UV florescent ink, a magnetic ink, a thermochromatic ink, a DNA tracking ink, and combinations thereof.

9. The system of claim 1, wherein the at least one image area of the stamp face comprises a heat-set gel ink.

10. The system of claim 1, wherein the system is removably coupleable with an embossing implement selected from the group consisting of a desktop embosser, handheld embosser, or automated embosser.

11. The system of claim 1, wherein the at least one raised image area and the at least one inked image area are formed on the substrate simultaneously.

12. The system of claim 1, wherein the at least one raised image area is formed on the substrate before or after the at least one inked image area is formed on the substrate.

13. A method of embossing and printing a substrate in a single machine process cycle, the method comprising:
providing a die set including—
a first die presenting a contact face having at least one recessed image area defined thereon,
a second, counter die presenting a contact face having at least one respective complementary raised image area defined thereon, and
a stamp die having at least one stamping image area defined thereon, the stamp face being positioned on the contact face of the first die or the second die;
placing a substrate in between the first die and the second die of the die set;
bringing the first die and the second die into contact thereby beginning the machine process cycle, wherein the at least one recessed image area of the first die and the at least one raised image area of the second die mate sandwiching the substrate in between, thereby forming at least one raised image area on the substrate, and wherein the stamp face contacts the substrate to form at least one inked image area on the substrate;
moving the first die and the second die away from each other, thereby completing the actuation cycle; and
removing the embossed and printed substrate from the die set.

14. The method of claim 13, wherein the stamp face is positioned on the contact face of the first die such that the at least one raised image and the at least one inked image is formed on a first major surface of the substrate.

15. The method of claim 13, wherein the stamp face is positioned on the contact face of the second die such that the at least one raised image is formed on a first major surface of the substrate and the at least one inked image is formed on a second, generally opposing major surface of the substrate.

16. The method of claim 13, wherein the die set further comprises a second stamp face positioned on the other contact face of the first or second die from the first stamp face, such that the at least one raised image and a first inked image is formed on a first major surface of the substrate, and a second inked image is formed on a second, generally opposing major surface of the substrate.

17. The method of claim 13, wherein each of the at least one stamping image areas is impregnated with ink.

18. The method of claim 17, wherein the ink comprises at least one of a UV florescent ink, a magnetic ink, a thermochromatic ink, a DNA tracking ink, and combinations thereof.

19. The method of claim 13, wherein the at least one raised image area and the at least one inked image area are formed on the substrate simultaneously.

20. The method of claim 13, wherein the at least one raised image area is formed on the substrate before or after the at least one inked image area is formed on the substrate.
